(19) United States
(12) Patent Application Publication
(10) Pub. No.: US 2007/0026742 A1
(43) Pub. Date: Feb. 1, 2007

(54) UTP cable for transmitting high frequency signal

(76) Inventors: Chan-Yong Park, Seoul (KR); Gi-Joon Nam, Seoul (KR); Jong-Seb Baeck, Gyeongsangbuk-do (KR); Woo-Yong Dong, Gyeongsangbuk-do (KR)

Correspondence Address: JONES DAY, 222 EAST 41ST ST, NEW YORK, NY, 10017, US

(21) Appl. No.: 11/489,910

(22) Filed: Jul. 19, 2006

(30) Foreign Application Priority Data
Jul. 28, 2005 (KR) KR10-2005-0069095

(51) Int. Cl. H01R 24/00

(52) U.S. Cl. 439/676

(57) ABSTRACT

A UTP (Unshielded Twisted Pair) cable having an electromagnetic wave shielding function is configured to allow transmission of over 10 Gbps level without align cross talk with an adjacent cable when using 500 to 700 MHz band. This UTP cable includes at least one wire pair in which two insulation-coated wires are spirally twisted, an electromagnetic wave shielding sheath surrounding the wire pair and made of polymer resin and conductive material, and an insulating sheath surrounding the electromagnetic wave shielding sheath and made of insulating material.

### BACKGROUND OF THE INVENTION

1. Field of the Invention

The present invention relates to a UTP (Unshielded Twisted Pair) cable, and more particularly to a UTP cable having a configuration capable of restraining alien cross talk in order to improve a transmission characteristic in a high frequency band.

2. Description of the Related Art

Generally, there are various kinds of data transmission cables. Among them, a UTP cable is an unshielded twisted pair cable used in a system requiring expedited and reliable mass data transmission of LAN (Local Area Network) or IBS (Intelligent Building System). Accordingly, the UTP cable is mainly used for PC (Personal Computer) communication using LAN, IBS and Internet or communication cable or multimedia service (for mass data transmission) in a house for dwelling.

The UTP cable includes a wire pair P in which two insulation-coated wires 100, 101 are spirally twisted as shown in FIG. 1, and it is generally configured in a bundle type in which at least two wire pairs are aggregated. Such an UTP cable is classified into Cat.3 (Category 3) (16 MHz), Cat.4 (20 MHz), Cat.5 (100 MHz) and Cat.6 (200 MHz) depending on a frequency standard. At this time, the transmission characteristic is more excellent as the numeral is greater. That is to say, more information may be transmitted as higher frequency is used.

Until now, an information transmission limit of the UTP cable was just about 155 Mbps. Recently, along with the development of transmission system technique, 1000 Mbps (1 Gbps) transmission using Cat.5 cable was enabled by using the compensation method by a device such as DSP (Digital Signal Processing). However, as the moving picture transmission technique is recently developed, a greater information transmission capacity is needed, and thus a high frequency is more used. Meanwhile, as a higher frequency is used, alien cross talk around the cable is greatly increased in an exponential functional relation. That is to say, as a higher modulation frequency is used, adjacent cables arranged to contact with each other are influenced from each other due to an electromagnetic field induced from a wire of a single cable. Thus, alien cross talk is generated between the adjacent cables, which makes it difficult to separate signals at a receiving end.

NEXT (Near End Cross Talk) or FEXT (Far End Cross Talk) is a representative cross talk. In order to solve the above problem, there have been many attempts in a way of using an inner separator having a cross-shaped section (having a ‘+’ shape) so as to avoid a contact among four wire pairs to the maximum, or controlling a twisting interval between pairs. In addition, like FTP (Foiled Twisted Pair) and STP (Shielded Twisted Pair), a metal film may be coated on the inside so as to endow an electromagnetic wave shielding characteristic.

FIG. 2 is a sectional view showing a configuration of a conventional FTP cable.

Referring to FIG. 2, the FTP cable includes a plurality of wire pairs 1 provided therein, an outer sheath layer 2 coated on the wire pairs 1, and a metal film 3 interposed between the wire pairs 1 and the sheath layer 2 to shield an electromagnetic wave. Here, the metal film 3 plays a role of protecting the wire pairs 1 against external cross talk as well as near-end cross talk.

However, in case the metal film is used for shielding like the FTP structure, there are drawbacks of heavy weight caused by increased density, bad flexibility, easy corrosion, and uneasy processing. In addition, the FTP structure disadvantageously requires additional processing works for manufacturing, consumes separate transport and carriage costs and other costs caused by inferior goods, and also shows much variation in the product performance depending on construction methods, which results in difficult maintenance.

### SUMMARY OF THE INVENTION

The present invention is designed to solve the problems of the prior art, and therefore it is an object of the present invention to provide a UTP cable capable of implementing a high transmission rate without any disturbance caused by alien cross talk even in a high frequency band over 500 MHz by endowing an electromagnetic wave shielding function to a sheath composition itself.

In order to accomplish the above object, the present invention provides an UTP (Unshielded Twisted Pair) cable, which includes at least one wire pair in which two insulation-coated wires are spirally twisted; an electromagnetic wave shielding sheath surrounding the wire pair and made of polymer resin and conductive material; and an insulating sheath surrounding the electromagnetic wave shielding sheath and made of insulating material.

Here, the electromagnetic wave shielding sheath may include 20 to 120 phr of conductive material on the basis of 100 phr of polymer resin, and the conductive material may be one selected from the group consisting of carbon black, acetylene black, metal fiber, conductive polymer and metal powder, or their mixtures.

Preferably, the conductive material includes 0 to 70 phr of acetylene black and 20 to 50 phr of conductive polymer on the basis of 100 phr of polymer resin.

In addition, the electromagnetic wave shielding sheath preferably has an electromagnetic wave shielding efficiency rate of 10 to 40 dB, and the electromagnetic wave shielding sheath preferably has a thickness of 0.5 to 2.5 mm.

Preferably, the UTP cable further includes a cross filler longitudinally inserted in the electromagnetic wave shielding sheath of the UTP cable so as to separate the wire pairs from each other.

In another aspect of the invention, there is also provided an UTP cable, which includes at least one wire pair in which two insulation-coated wires are spirally twisted; an electromagnetic wave shielding sheath surrounding the wire pair and made of polymer resin and conductive material; an inner insulating layer coated on an inner surface of the magnetic wave shielding sheath; and an insulating sheath surrounding the electromagnetic wave shielding sheath and made of insulating material.

### BRIEF DESCRIPTION OF THE DRAWINGS

Other objects and aspects of the present invention will become apparent from the following description of embodiments with reference to the accompanying drawing in which:

FIG. 1 is a perspective view showing a common wire pair provided in a UTP (Unshielded Twisted Pair) cable;

FIG. 2 is a sectional view showing a configuration of a conventional FTP (Foiled Twisted Pair) cable;

FIG. 3 is a sectional view showing a configuration of a UTP cable according to one embodiment of the present invention;

FIG. 4 is a sectional view showing a configuration of a UTP cable according to another embodiment of the present invention;

FIG. 5 is a graph showing a shielding efficiency of an electromagnetic wave shield used in the present invention;

FIG. 6 is a graph showing a transmission characteristic of the UTP cable according to one embodiment of the present invention; and

FIG. 7 is a graph showing a transmission characteristic of a conventional UTP Cat.6 cable.

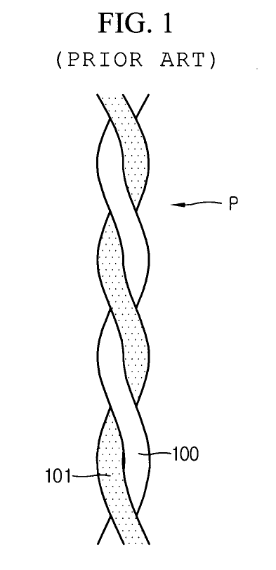

### DESCRIPTION OF THE PREFERRED EMBODIMENT

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

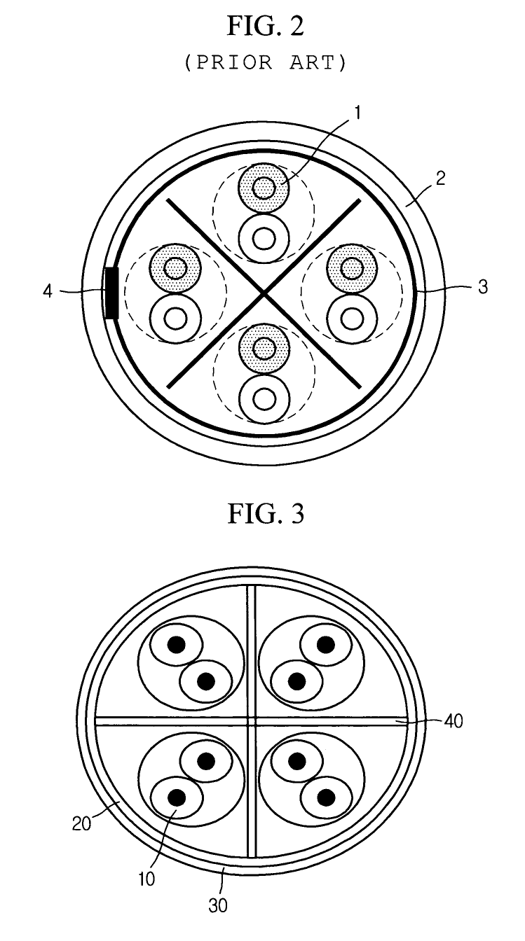

FIG. 3 is a cross-sectional view showing a configuration of a UTP (Unshielded Twisted Pair) cable according to one embodiment of the present invention.

Referring to FIG. 3, the TUP cable of this embodiment includes at least one wire pair 10 in which two insulation-coated wires are spirally twisted, an electromagnetic wave shielding sheath 20 surrounding the wire pair and made of polymer resin and conductive material, and an insulating sheath 30 surrounding the electromagnetic wave shielding sheath 20 and made of insulating material.

The UTP cable is configured so that a plurality of wire pairs in each of which two insulation-coated wires are spirally twisted with each other are aggregated in a sheath. For example, four wire pairs 10 are aggregated in the sheath of the UTP cable, and at this time a pitch difference among the pairs is preferably kept in the range of 0.5 to 7.5 mm, more preferably 1.0 to 7.0 mm, so as to minimize mutual electromagnetic actions. Here, the number of wire pairs may be variously changed, not limited to the above example.

Additionally, a cross filler 40 for preventing alien cross talk among the wire pairs is longitudinally inserted in the UTP cable provided with a plurality of the wire pairs 10.

The cross filler 40 separates the wire pairs 10 from each other and thus prevents alien cross talk among the wire pairs 10. Specifically, the cross filler 40 is configured so that four partitions are crossed with each other between the wire pairs 10 to isolate each wire pair 10. At this time, the cross filler 40 preferably has a thickness of 0.2 to 1.0 mm. This cross filler 40 spaces the wire pairs 10 apart from each other to the maximum, thereby decreasing alien cross talk between adjacent wire pairs 10.

The electromagnetic wave shielding sheath 20 is coated to surround the wire pair 10 and made of polymer resin and conductive material. The conductive material having an electromagnetic wave shielding characteristic may use one selected from carbon black, acetylene black, metal fiber, conductive polymer and metal powder, or their mixtures. At this time, in order to improve the shielding characteristic, the electromagnetic wave shielding sheath 20 preferably includes 20 to 120 phr of conductive material on the basis of 100 phr of the polymer resin. If the content of conductive material is less than 20 phr, it is difficult to obtain a satisfactory electromagnetic wave shielding efficiency. In addition, if the content of conductive material is greater than 120 phr, an electromagnetic wave shielding characteristic may be given but it does not allow easy extrusion since a mechanical strength is deteriorated and the material becomes hard or fragile.

Preferably, the conductive material included in the electromagnetic wave shielding sheath may be composed of 0 to 70 phr of acetylene black and 20 to 50 phr of conductive polymer. The conductive polymer keeps its aggregation and shows excellent shielding characteristic when being used as a compound, but it becomes hard when a great amount of conducive polymer is used alone. In addition, when being used alone, the acetylene black is soft but its shielding characteristic is not good. Thus, the shielding characteristic and the extrusion characteristic may be ensured together when acetylene black and conducive polymer are mixed in the above ranges.

In addition, the electromagnetic wave shielding sheath 20 used in the present invention preferably has an electromagnetic wave shielding efficiency rate of 10 to 40 dB in order to optimize the transmission characteristic, and its thickness is preferably 0.5 to 2.5 mm. In case the thickness of the electromagnetic wave shielding sheath 20 is smaller than 0.5 mm, the shielding characteristic is not easily shown, while, in case the electromagnetic wave shielding sheath 20 is thicker than 2.5 mm, the UTP cable is excessively thickened.

The insulating sheath 30 is coated to surround the electromagnetic wave shielding sheath 20 and provided to an outermost position of the UTP cable. Accordingly, the insulating sheath 30 may ensure an insulating characteristic against external environments and also isolates conductivity caused by the electromagnetic wave shielding sheath 20. The insulating sheath 30 preferably has a thickness of 1 to 2 mm. If the thickness is less than 1 mm, the insulating sheath 30 may not have required tensile strength and elongation as a coating material, while, if the thickness is greater than 2 mm, much materials are unnecessarily consumed and the weight of the UTP cable is greatly increased.

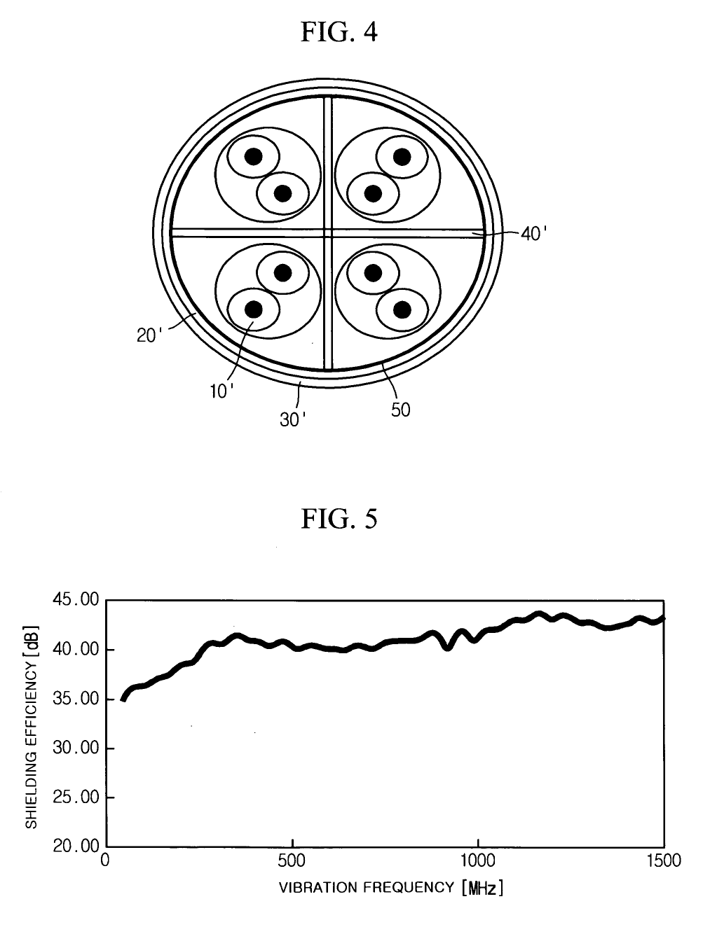

FIG. 4 is a cross-sectional view showing a configuration of a UTP cable according to another embodiment of the present invention.

Referring to FIG. 4, the UTP cable according to another embodiment of the present invention includes at least one wire pair 10′ in which two insulation-coated wires are spirally twisted, an electromagnetic wave shielding sheath 20′ surrounding the wire pair 10′ and made of polymer resin and conductive material, and an insulating sheath 30′ surrounding the electromagnetic wave shielding sheath 20′ and made of insulating material, and an inner insulating layer 50 is coated on an inner surface of the electromagnetic wave shielding sheath 20′.

The inner insulating layer 50 is coated on the inner side of the electromagnetic wave shielding sheath 20′ to restrain electric effects therefrom. Thus, if the inner insulating layer 50 is used, it is possible to ensure more stable characteristic. Specifically, since the electromagnetic wave shielding sheath has conductivity, it is influenced by skin effect when a signal is transmitted using a high frequency. Then, the sheath having conductivity absorbs the transmission energy due to the skin effect. Thus, as a frequency is higher than 200 MHz, attenuation is generated. To prevent this, it is preferred that an insulating layer is used for separating the electromagnetic wave shielding sheath and the inner core. The insulating layer may adopt an insulating film.

Here, the inner insulating layer 50 preferably has a thickness of 0.1 to 0.5 mm. If the thickness of the inner insulating layer 50 is less than 0.1 mm, it is not effective to reduce attenuation caused by the skin effect. In addition, if the thickness of the inner insulating layer 50 is greater than 0.5 mm, the cable grows unnecessarily large and heavy and does not allow easy processing.

Now, a method for manufacturing a UTP cable according to the preferred embodiment of the present invention will be described in detail.

### EMBODIMENT

First, in order to manufacture a UTP cable having a transmission characteristic over 10 Gbps even in a high frequency band in the range of 500 to 650 MHz, two insulation-coated wires were spirally twisted to form a wire pair, and four wire pairs were prepared in this way.

If four wire pairs were prepared, the wire pairs were positioned between wings of the cross-shaped cross filler with a thickness of about 0.3 mm, one by one. Then, an aggregation in which four wire pairs are separated from each other by means of the cross-shaped cross filler was formed.

After that, a plurality of sheath layers coated to surround the aggregation were formed. First, in order to make an electromagnetic wave shielding sheath having an electromagnetic wave shielding function, polymer resin and conductive material were prepared. As for the polymer resin, EVA421 manufactured by DuPont in USA was basically used, and carbon black was used as the conductive material. Polymer resin (EVA421), conductive material (carbon black), binder and other additives were mixed in contents of 100 phr, 70 phr, 10 phr and small portions respectively into a mixture whose entire amount is 190 phr so as to make an electromagnetic wave shielding sheath. An electromagnetic wave shielding characteristic of the electromagnetic wave shielding sheath made as mentioned above was evaluated using the network analyzer of Hewlett Packard. As a result of evaluating the electromagnetic wave shielding sheath made according to the present invention, it was found that it shows an excellent shielding efficiency rate in the level of about 30 dB (˜99.9%) in the range of 500 to 650 MHz (see FIG. 5).

In addition, in order to intercept a conductive effect of the electromagnetic wave shielding effect, the aggregation composed of the wire pairs may be coated with an inner insulating layer, and the inner insulating layer may adopt a polyethylene (PE) film. At this time, the used inner insulating layer preferably has a thickness of 0.2 mm.

The wire pair aggregation provided with the inner insulating layer is mounted to an extrusion dies together with the interior electromagnetic wave shielding sheath and the exterior insulating sheath and then extruded together in a co-extrusion manner. Preferably, the electromagnetic wave shielding sheath and the insulating sheath pushed by pressure of the extrusion dies respectively have thicknesses of 2 mm and 1.2 mm.

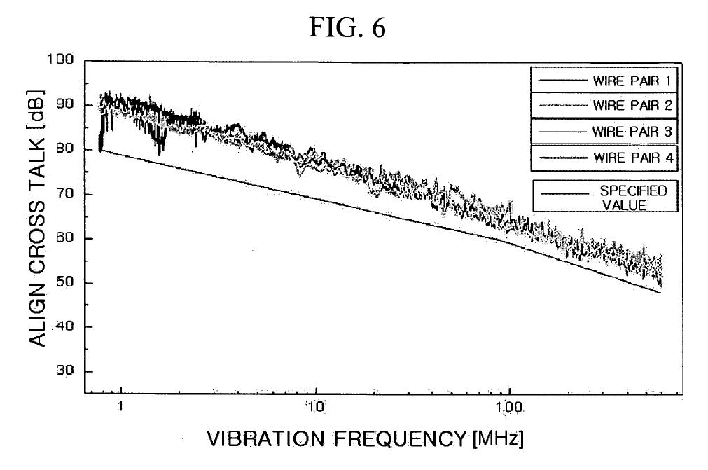

FIG. 6 is a graph showing a transmission characteristic of the UTP cable manufactured according to the preferred embodiment of the present invention. As shown in FIG. 6, as a result of measuring 10 Gbps transmission characteristics, alien cross talk with adjacent cables exceeds a specified value recommended by IEEE (Institute of Electrical and Electronics Engineers) in the four wire pairs, namely in all of the first wire pair, the second wire pair, the third wire pair and the fourth wire pair, so they show excellent characteristics enabling 10 Gbps transmission.

### COMPARATIVE EXAMPLE

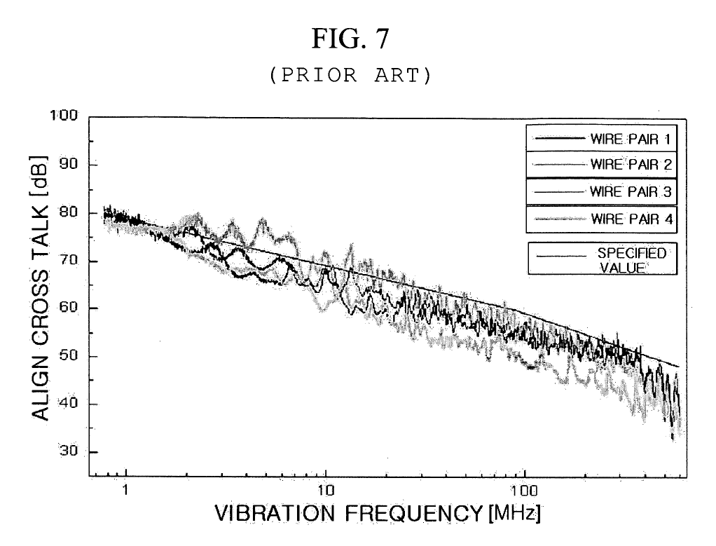

10 Gbps transmission characteristics were checked for Cat.6 product having the most excellent transmission characteristic among conventional UTP cables, in the same way as in the above embodiment. As a result, it was found that cross talk between wire pairs due to adjacent cables was very serious, thereby greatly falling short of the specified value recommended by IEEE (see FIG. 7).

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### APPLICABILITY TO THE INDUSTRY

According to the present invention, since a sheath having an electromagnetic wave shielding function is provided to a UTP cable, it is possible to intercept exterior noise caused by cross talk with adjacent cables even in a high frequency band of 500 to 700 MHz, which allows using a high-speed communication cable enabling transmission of over 10 Gbps level.

In addition, the present invention endows an electromagnetic wave shielding function to the sheath composition itself, so there is no need of separate structure change and it advantageously allows convenient manufacturing.

What is claimed is:

1. An UTP (Unshielded Twisted Pair) cable, comprising:
at least one wire pair in which two insulation-coated wires are spirally twisted;
an electromagnetic wave shielding sheath surrounding the wire pair and made of polymer resin and conductive material; and
an insulating sheath surrounding the electromagnetic wave shielding sheath and made of insulating material.

2. The UTP cable according to claim 1,
wherein the conductive material of the electromagnetic wave shielding sheath is one selected from the group consisting of carbon black, acetylene black, metal fiber, conductive polymer and metal powder, or their mixtures.

3. The UTP cable according to claim 2,
wherein the mixture includes conductive polymer or acetylene black.

4. The UTP cable according to claim 1,
wherein the electromagnetic wave shielding sheath includes 20 to 120 phr of conductive material on the basis of 100 phr of polymer resin.

5. The UTP cable according to claim 1,
wherein the conductive material includes 0 to 70 phr of acetylene black and 20 to 50 phr of conductive polymer on the basis of 100 phr of polymer resin.

6. The UTP cable according to claim 1,
wherein the electromagnetic wave shielding sheath has an electromagnetic wave shielding efficiency rate of 10 to 40 dB.

7. The UTP cable according to claim 1,
wherein the electromagnetic wave shielding sheath has a thickness of 0.5 to 2.5 mm.

8. The UTP cable according to claim 1,
wherein the insulating sheath has a thickness of 1.0 to 2.0 mm.

9. The UTP cable according to claim 1,
wherein the at least one wire pair has different pitch values.

10. The UTP cable according to claim 9,
wherein the at least one wire pair has a pitch difference of 0.5 to 7.5 mm.

11. The UTP cable according to claim 9,
wherein the at least one wire pair has a pitch difference of 1.0 to 7.0 mm.

12. The UTP cable according to claim 1, further comprising a cross filler longitudinally inserted in the electromagnetic wave shielding sheath of the UTP cable so as to separate the wire pairs from each other.

13. The UTP cable according to claim 12,
wherein the cross filler has a thickness of 0.2 to 1.0 mm.

14. An UTP cable, comprising:
at least one wire pair in which two insulation-coated wires are spirally twisted;
an electromagnetic wave shielding sheath surrounding the wire pair and made of polymer resin and conductive material;
an inner insulating layer coated on an inner surface of the magnetic wave shielding sheath; and
an insulating sheath surrounding the electromagnetic wave shielding sheath and made of insulating material.

15. The UTP cable according to claim 14,
wherein the conductive material of the electromagnetic wave shielding sheath is one selected from the group consisting of carbon black, acetylene black, metal fiber, conductive polymer and metal powder, or their mixtures.

16. The UTP cable according to claim 15,
wherein the mixture includes conductive polymer or acetylene black.

17. The UTP cable according to claim 14,
wherein the electromagnetic wave shielding sheath includes 20 to 120 phr of conductive material on the basis of 100 phr of polymer resin.

18. The UTP cable according to claim 14,
wherein the conductive material includes 0 to 70 phr of acetylene black and 20 to 50 phr of conductive polymer on the basis of 100 phr of polymer resin.

19. The UTP cable according to claim 14,
wherein the electromagnetic wave shielding sheath has an electromagnetic wave shielding efficiency rate of 10 to 40 dB.

20. The UTP cable according to claim 14,
wherein the electromagnetic wave shielding sheath has a thickness of 0.5 to 2.5 mm.

21. The UTP cable according to claim 14,
wherein the insulating sheath has a thickness of 1.0 to 2.0 mm.

22. The UTP cable according to claim 14,
wherein the at least one wire pair has different pitch values.

23. The UTP cable according to claim 22,
wherein the at least one wire pair has a pitch difference of 0.5 to 7.5 mm.

24. The UTP cable according to claim 22,
wherein the at least one wire pair has a pitch difference of 1.0 to 7.0 mm.

25. The UTP cable according to claim 14, further comprising a cross filler longitudinally inserted in the electromagnetic wave shielding sheath of the UTP cable so as to separate the wire pairs from each other.

26. The UTP cable according to claim 25,
wherein the cross filler has a thickness of 0.2 to 1.0 mm.

27. The UTP cable according to claim 14,
wherein the inner insulating layer has a thickness of 0.1 to 0.5 mm.
